(19) United States
(12) Patent Application Publication
(10) Pub. No.: US 2013/0114204 A1
(43) Pub. Date: May 9, 2013

(54) HEAT REMOVAL SYSTEM FOR COMPUTING SYSTEMS

(71) Applicant: Jay S. NIGEN, Mountain View, CA (US)

(72) Inventor: Jay S. NIGEN, Mountain View, CA (US)

(73) Assignee: Apple Inc., Cupertino, CA (US)

(21) Appl. No.: 13/598,560

(22) Filed: Aug. 29, 2012

Related U.S. Application Data
(60) Provisional application No. 61/555,819, filed on Nov. 4, 2011.

(51) Int. Cl. F28D 15/00; G06F 1/20; F28D 15/02

(52) U.S. Cl. 361/679.48; 165/104.14

(57) ABSTRACT

A low profile heat removal system suitable for removing excess heat generated by a component operating in a compact computing environment is disclosed. The low profile heat removal system is capable of removing disproportionately high amounts of heat given its small form factor, by virtue of a highly efficient staggered cooling fin configuration.

### CROSS-REFERENCE TO RELATED APPLICATION

This application claims priority to and benefit under 35 U.S.C. 119(e) of U.S. Provisional Patent Application Ser. No. 61/555,819, filed Nov. 4, 2011, entitled HEAT REMOVAL SYSTEM FOR COMPUTING SYSTEMS, the entire disclosure of which is hereby incorporated by reference.

### BACKGROUND

1. Technical Field

This invention relates generally to heat rejection in computing devices. The computing devices can include desktop computers, laptop computers and in particular, providing a heat removal system that efficiently removes heat while retaining a reduced footprint.

2. Related Art

Compact computing devices such as laptop computers, netbook computers, etc. have become ever smaller, lighter and more powerful. One factor contributing to this reduction in size can be attributed to the manufacturer's ability to fabricate various components of these devices in smaller and smaller sizes, assembling the components in ever more dense configurations, and in most cases increasing the power and or operating speed of such components. As processor power and speed has increased, however, so too has the excess heat generated. As the density of the internal components has increased, the ability to efficiently remove the excess heat generated by those operating components having a high heat flux has been become ever more difficult and costly.

A heat pipe is a heat transfer mechanism that can transport large quantities of heat with a very small difference in temperature between the hotter and colder interfaces and is therefore well suited for use in laptop computers, and other high density, compact computing environments. A typical heat pipe consists of a sealed pipe or tube made of a material with high thermal conductivity such as copper or aluminum. The heat pipe includes a working fluid, (or coolant), chosen to match the operating temperature of the compact computing device. Some example fluids are water, ethanol, acetone, sodium, or mercury. (Clearly, due to the benign nature and excellent thermal characteristics, water is used as the working fluid in consumer products such as laptop computers.) Inside the heat pipe's walls, an optional wick structure exerts a capillary pressure on the liquid phase of the working fluid. The wick structure is typically a sintered metal powder or a series of grooves parallel to the heat pipe axis, but it may be any material capable of exerting capillary pressure on the condensed liquid to wick it back to the heated end. It should be noted, however, that the heat pipe may not need a wick structure if gravity or some other source of acceleration is sufficient to overcome surface tension and cause the condensed liquid to flow back to the heated end.

Space or volume is at a premium in compact computer environments and it is essential that any heat removal system must be able to maximize heat transfer while minimizing the space occupied. In addition to minimizing the space required, it is desirable that the heat removal system be relatively inexpensive to fabricate. The cost of fabrication is relatively high when the heat removal system is fabricated from especially dedicated and unique components as distinguished from being fabricated from stock materials.

Although the prior art effectively dissipates heat from electronic devices, there is a continuing need for alternative designs that do not substantially add additional height to the existing Z stack height, that effectively dissipate heat and are relatively inexpensive to fabricate.

### SUMMARY

The embodiments relate to a system, and methods for efficiently removing heat from components in a compact computing system such as a laptop or small form factor computer.

In one embodiment, a compact computer heat removal system used for removing heat generated by an integrated circuit is described. In the described embodiment, the integrated circuit is mounted to a substrate that in turn is mounted to a motherboard. The heat removal system includes at least a heat pipe in thermal contact with the integrated circuit, the heat pipe is arranged to carry a heat exchanging medium that is used to transfer heat generated by the integrated circuit to an external heat sink in thermal contact with the heat pipe. In one embodiment, the external heat sink takes the form of a heat exchanger formed of a first array of cooling fins and a second array of cooling fins. In order to improve heat exchange capability the first and second arrays of cooling fins are staggered a staggering distance d in a first direction and distance “t” in a second direction. The staggering distance d is such that each of the second set of cooling fins is about halfway between corresponding ones of the first set of cooling fins, and wherein the distance “t” is less than a distance in which boundary layers formed by friction between a coolant flow and the first plurality of fins combine to substantially occlude the coolant flow, wherein the staggering of the first and the second cooling fins causes a central more thermally receptive portion of the coolant flow to flow over and come in contact with the second array of cooling fins, thereby increasing a cooling efficiency of the heat exchanger;

In one aspect of the described embodiments, heat is transferred between the staggered fins and the cooling medium using a forced convection process whereby the cooling medium is directed through the staggered cooling fins by way of a cooling medium transport mechanism. For example, when the cooling medium is air, the cooling medium transport mechanism is a centrifugal fan having an impeller and rotor. Due to the increase in heat transfer due to the staggered fins, the volume and velocity of air required to adequately cool the integrated circuit is reduced thereby commensurably reducing an amount of power required to actively cool the integrated circuit.

In another embodiment a method for removing heat generated by an integrated circuit is described. In the described embodiment, the integrated circuit is mounted to a substrate that in turn is mounted to a motherboard. The method can be carried out by performing at least the following operations. Providing a heat transfer mechanism in the form of a heat tube integrally connected to a staggered fin cooling mechanism and a cooling fan assembly. The cooling fan assembly causes a cooling medium in the form of air to traverse the staggered fin cooling mechanism that, in turn, causes heat to be transferred from the heat tube to the air by way of the staggered fins. Power supplied to the fan assembly is reduced commensurate with the increase in overall efficient heat transfer due to the staggered fin cooling mechanism.

In yet another embodiment a portable computer system is disclosed including at least the following components: (1) a motherboard; (2) a number of integrated circuits mounted to the motherboard; (3) a heat pipe in thermal contact with each of the integrated circuits, the heat pipe arranged to transfer heat away from the integrated circuits; (4) a high efficiency heat exchanger in thermal contact with the heat pipe, configured to dissipate heat removed by the heat pipe from the plurality of integrated circuits, the heat exchanger including a plurality of staggered cooling fins; and (5) a fan configured to force external coolant flow first across at least one of the plurality of integrated circuits and subsequently across the heat exchanger. The high efficiency of the staggered fin heat exchanger reduces a convective transfer of heat between the forced external coolant flow and the at least one integrated circuit, thereby allowing the forced external coolant flow to arrive at the high efficiency heat exchanger at a lower temperature than it would otherwise given a lower efficiency heat exchanger.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 is a view of a representative motherboard found in a small computer, such as a laptop and a cross sectional view of a portion of the motherboard;

FIGS. 2A and 2B show a perspective view and head on and, respectively, of staggered fin assembly;

FIG. 3A shows a cross-sectional top view of the staggered fin assembly shown in FIG. 2A and 2B;

FIG. 3B shows a restricted view of a portion of the staggered fin assembly shown in FIG. 3A;

FIG. 4 is a view of coolant flow across a representative motherboard found in a small form factor computer;

FIG. 5A shows a cross-sectional top view of a staggered fin assembly having three rows of staggered fins;

FIG. 5B shows a restricted view of a portion of the staggered fin assembly shown in FIG. 5A; and

FIG. 6 shows a flowchart detailing a process in accordance with the described embodiments.

### DETAILED DESCRIPTION

Reference will now be made in detail to selected embodiments an example of which is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as can be included within the spirit and scope of the invention as defined by the appended claims.

The described embodiments relate to an efficient, reduced profile heat removal system well suited for use in computing systems such as desktop computers, laptop computers, etc. In the described embodiments, the compact heat removal system can include a heat pipe. A heat pipe is a simple device adapted to quickly transfer heat from one point to another. The heat pipe itself includes a sealed aluminum or copper container having inner surfaces formed of capillary wicking material. The heat pipe can transport heat against gravity by an evaporation-condensation cycle with the help of porous capillaries that can provide the wicking action in the form of a capillary driving force to return the condensate to the evaporator. The heat pipe is well suited for use in computing systems that require efficient transfer of heat from various components such as a CPU, graphics processor, and so on. The heat pipe can be generally light weight and have a small compact profile. Moreover, its passive operation makes it particularly useful in small computing systems, such as laptop computers.

Heat pipes remove heat from the source in a two-phase process. As heat is generated, a liquid at one end of the pipe evaporates and releases the heat to a heat sink by condensation at the other end. The liquid is returned to start the process over through a wick structure on the inside of the heat pipe. Heat pipes passively transfer heat from the heat source to a heat sink where the heat is dissipated. The heat pipe itself is a vacuum-tight vessel that is evacuated and partially filled with a minute amount of water or other working fluid. As heat is directed into the device, the fluid is vaporized creating a pressure gradient in the pipe. This forces the vapor to flow along the pipe to the cooler section where it condenses, giving up its latent heat of vaporization. The working fluid is then returned to the evaporator by capillary forces developed in the heat pipe's porous wick structure, or by gravity.

The following description enumerates several embodiments of heat removal systems well suited for computing environments such as laptop computers. Throughout the description reference is made to Z stack and Z stack height. A Z stack can be interpreted to mean those components incorporated onto a motherboard of the laptop computer that is located within the footprint of an operational component (such as the central processing unit, or CPU). These components can be “stacked” one atop the other in the Z direction (i.e., Z stack) measured in the Z direction to have a Z stack height. For example, a CPU stack can include a motherboard, a substrate mounted to the motherboard, the CPU mounted to the substrate, and a heat removal system for removing excess heat from the CPU. In computing systems that have a thin profile, such as a laptop, it would clearly be advantageous for the CPU stack (in this example) to have as minimal height as possible.

One way to reduce the stack height of the heat exchanger is to increase the efficiency of the fin configuration. By creating a higher efficiency fin configuration the overall volume taken up by the heat exchanger can be commensurably reduced. For example, cooling fins that are spaced closer together are more efficient; however, once traditionally configured cooling fins are spaced too closely together larger pressure drops can result from parasitic drag between the surface of the fins and the coolant fluid. When the fins are spaced too closely together the parasitic drag begins near the surface of the fins creating a region of slower moving coolant fluid. As the coolant fluid continues to move between the cooling fins the region of slower moving coolant fluid gets larger until it takes up the entire channel. Once the entire channel is covered by the slower moving coolant fluid a significant decrease in coolant flow occurs. In a traditional cooling fin configuration the only way to overcome such a problem is to leave the pitch between the cooling fins large enough to prevent the convergence of the slower moving air regions. As explained above such a configuration is undesirable since an increase in efficiency can only be achieved by making the fins taller, or extending the width of the heat exchanger. Either option undesirably increases the overall volume of the heat exchanger, thereby taking up additional space that may not be available in a small form factor device.

In one embodiment two arrays of cooling fins horizontally staggered from each other can be used to overcome these problems. With the staggered cooling fin configuration the convergence of slower flowing coolant regions can be prevented by interrupting the coolant flow just prior to a convergence point with an horizontally offset set of fins. Fast flowing, cooler fluid in the middle of the cooling fin channel then comes into contact with the offset fins. The fast flowing cooler fluid is then slowed down from its contact with the cooling fin, and the offset fin is made more efficient since it is put in direct contact with the coolest part of the coolant fluid. The slower portion of the coolant fluid is then pushed out into the center of the next set of staggered fins where it can speed back up and be subject to less heating from the cooling fins. In this way a more highly efficient heat exchanger can be configured without the same pressure drop penalties that would result from a traditionally configured heat exchanger with the same cooling fin channel width.

It should be noted that the use of staggered cooling fins in portable electronic devices has been largely ignored since theoretical modeling tends to show that any advantage gained by the use of such a configuration would be overshadowed by a corresponding increase in fan power output to overcome the associated pressure drop resulting from the staggered fan configuration. Since power consumption is an important consideration especially in portable computing platforms such as laptop computers, or just about any battery powered device, this drawback has prevented designers from considering such a configuration. However, when staggered fins are coupled with other heat transfer processes, the increased efficiency of the cooling fins can allow other heat transfer processes to be advantageously balanced, thereby yielding an overall efficiency gain, as will be discussed in detail below.

Another advantage of the described staggered fin cooling mechanism is that the improvement in overall heat transfer efficiency between a cooling medium, such as air, that is forced to flow between the staggered fins of the staggered fin cooling mechanism can translate into a reduced amount of air that must be transported across the staggered fins. This reduction in the amount of air that must be transported across the staggered fins can result in a reduced need for power delivered to a corresponding cooling fan assembly. This reduction in power to the cooling fan assembly can be a result of a reduced amount of air required for removal of a unit amount of heat (a measure of heat removal efficiency), a reduced speed of rotation of an impeller/rotor in the cooling fan assembly, and less time that the cooling fan assembly must be used to transport the air. The reduced flow of air out of the portable electronic device can in addition to the reduction in power consumption also result in a reduced noise level thereby enhancing a user's overall experience with the portable computing platform.

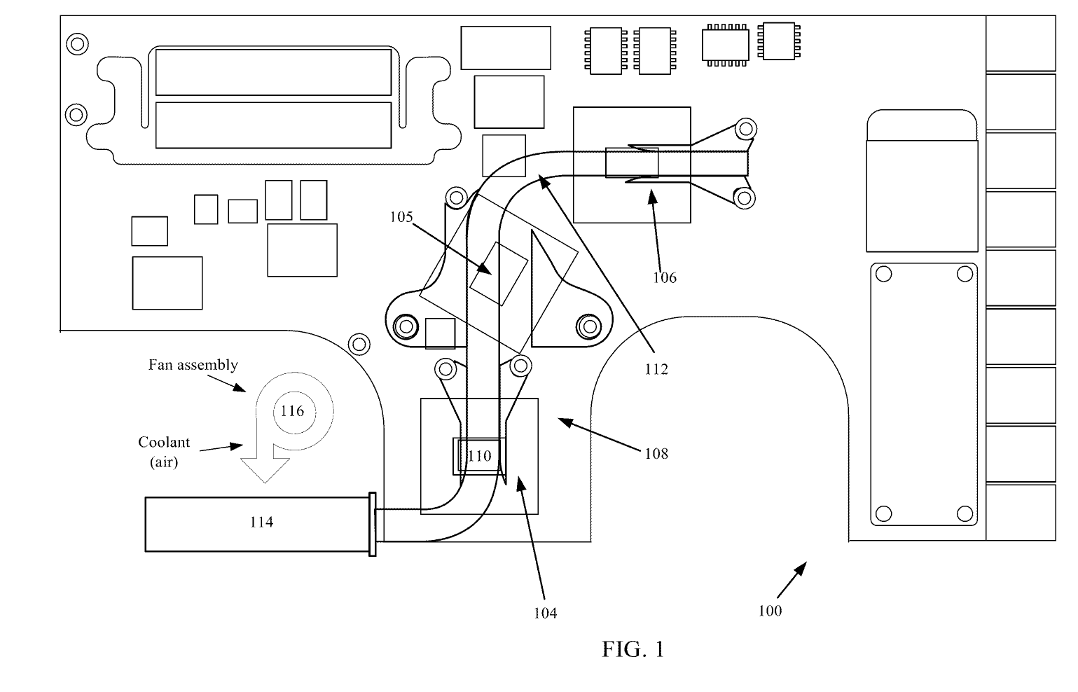

Various embodiments of heat removal systems suitable for compact computing environments, such as laptop computers, are discussed below with reference to FIGS. 1-6. However, those skilled in the art will readily appreciate that the detailed description given herein with respect to these figures is for explanatory purposes as the full extent of the embodiments goes beyond these limited descriptions.

FIG. 1 shows a “bird's eye view” of representative mother board 100 in accordance with the described embodiments. In order to more clearly illustrate the various aspects of motherboard 100, a first view of motherboard 100 is shown without a heat removal system being physically present but nonetheless represented in dotted line form. Accordingly, motherboard 100 can include a number of components (such as processor die 104, graphics processing unit, or GPU, 105, and chip set 106) each of which can generate substantial heat while operating. Using processor die 104 as an example, processor die 104 is mounted to substrate 108 that in turn is mounted to motherboard 100. Viewed from above, slug 110 is seen mounted on top of processor die 104. Slug 110 can be formed of copper or any other thermally conductive material. Typically, in order to improve the thermal contact between processor die 104 and slug 110, thermally conductive material (sometimes referred to as thermal grease) can be applied to a top portion of processor die 104 prior to the placement of slug 110. In this way, the thermal resistance at the junction of processor dies 104 and slug 110 can be reduced.

By reducing the thermal resistance at the junction of slug 110 and processor die 104, a path of reduced resistance to heat flow can be formed such that heat will preferentially flow from processor die 104 to slug 110 and further to the heat removal system. Accordingly, a substantial portion of the heat generated by processor die 104 can flow to and through slug 110 as a primary heat flow. To a lesser extent, heat can flow from processor die 104 to motherboard 100 by way of substrate 108 as a secondary, less desirable, heat flow. The heat can in turn be transported by way of heat tube 112 to staggered fin cooling mechanisms 114 for removal of the computing system by way of cooling medium (which in this example is air) delivered by way of fan assembly 116. It should be noted that in some applications, the efficiency of staggered fin cooling mechanism 114 can be such that fan assembly 116 is not required and adequate cooling can be achieved by way of convective transfer between the cooling medium (air) and staggered fin cooling mechanism 114.

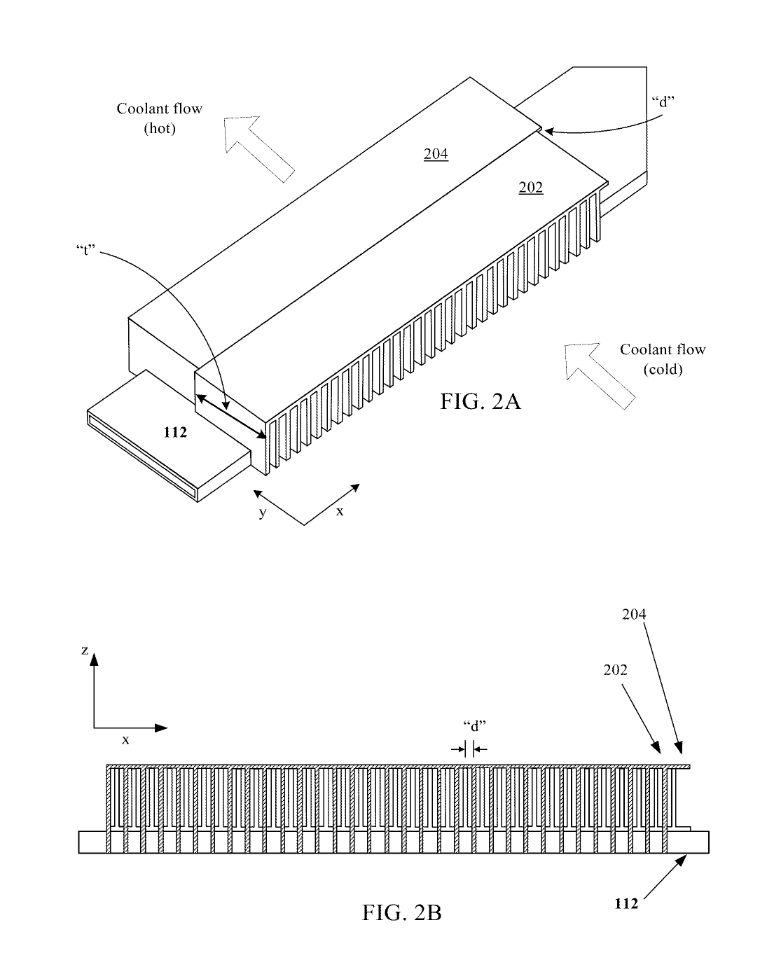

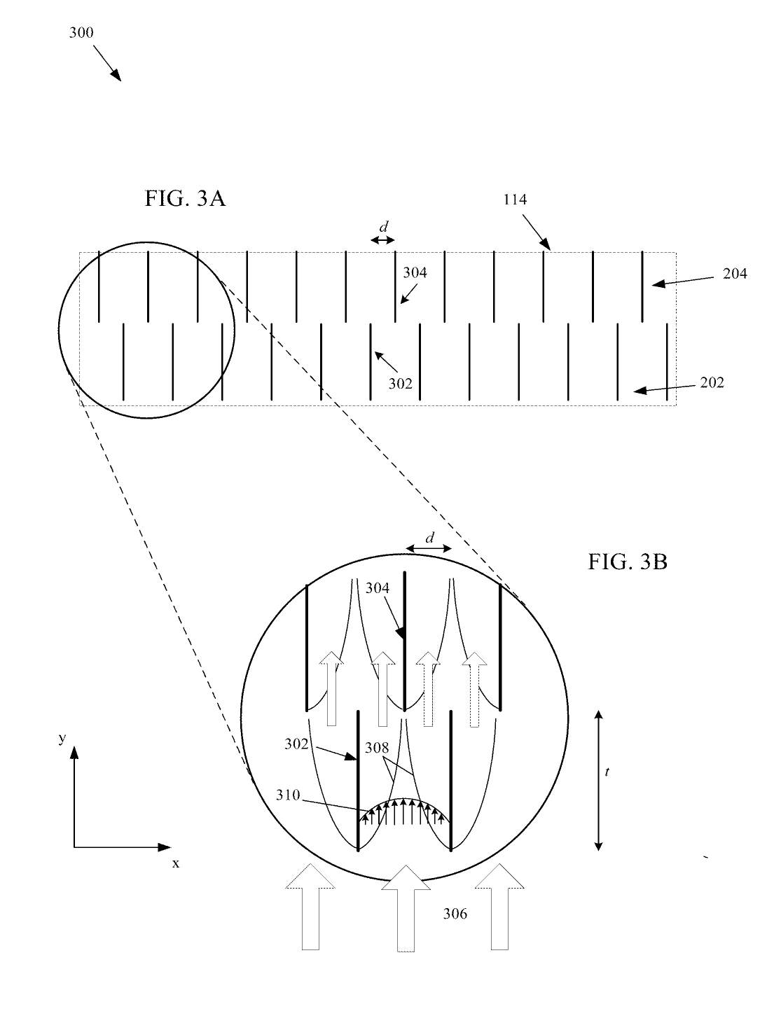

FIGS. 2A and 2B show a perspective view and head on and, respectively, of staggered fin assembly 114. In particular, as shown in FIG. 2A, first plurality 202 of cooling fins and second plurality 204 of cooling fins are staggered with respect to each other by a staggering distance “d”. Staggering distance d represents a distance that allows an efficient conductive heat transfer between corresponding ones of cooling fins in first plurality 202 and second plurality 204 as illustrated in FIG. 3A.

In particular, FIG. 3A shows a top down cross-sectional view 300 of representative cooling fins 302 corresponding to first plurality of cooling fins 202 and cooling fins 304 representative of second plurality of cooling fins 204 each of which are displaced in the “x” direction the staggering distance d and in the “y” direction a distance “t”. In a preferred embodiment distance d can be set to a value placing fins 304 halfway between corresponding fins 302, as depicted. Distance “t” can be set to a distance which is roughly equal to the distance coolant flow 306 must travel before being significantly overcome by viscosity effects. These effects stem from friction between coolant flow 306 and fins 302, forming slower areas of flow depicted by plumes 308. As coolant flow 306 travels along fins 302 plumes 308 increase in size until the plumes join together, at which point coolant flow 306 is substantially slowed. By staggering fins 304 with fins 302 coolant flow 306 can be disrupted before it is substantially slowed by the merging of plumes 308. It is important to note that since the central portion of coolant flow 306 is farthest from fins 302 it is the coolest portion of the flow. The central portion of coolant flow 308 is also the fastest moving as it is farthest from the viscous effects caused by interaction with fins 302. A representation of this velocity variation is depicted by velocity profile 310. Consequently, once coolant flow 306 hits fins 304 the fastest moving and coolest portion of coolant flow 306 comes into direct contact with fins 304, thereby maximizing heat transfer between coolant flow 306 and fins 304. In this way, once coolant flow 306 transitions into cooling fins 304 velocity and thermal variations are partially normalized until drag between cooling fins 304 and the normalized coolant flow 306 once again causes significant variations in the coolant flow's velocity and temperature. It should be noted that while only two sets of staggered fins are shown in this embodiment any number of staggered fins can be utilized in other configurations, thereby allowing for longer active cooling pathways.

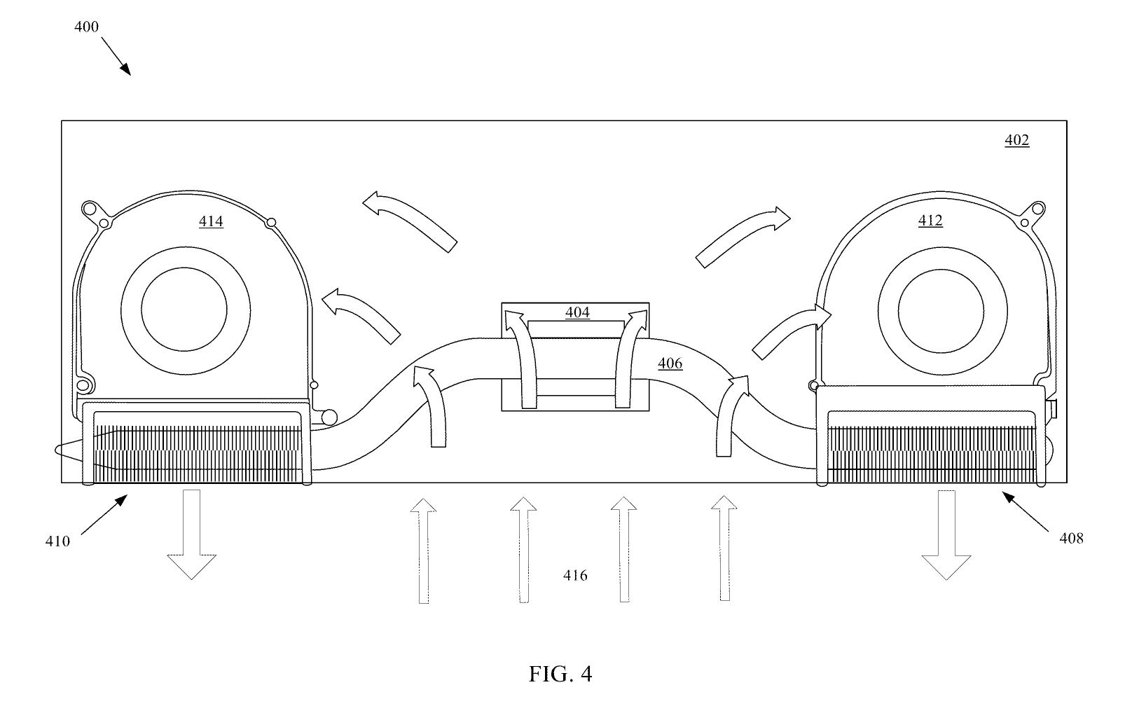

FIG. 4 shows a cooling system for a portable computing device 400. For exemplary purposes only a small portion of portable computing device 400 is depicted. Portable computing device 400 includes a motherboard 402 having a processor 404 mounted on it with the capacity to generate large amounts of heat. The cooling system includes heat pipe 406 in thermal contact with processor 404. Heat passing by conduction into heat pipe 406 is subsequently transferred to staggered cooling fin arrays 408 and 410. Fan assemblies 412 and 414 can be initiated when passive cooling alone is insufficient to reject enough heat from processor 404. Once fans 412 and 414 are initiated coolant flow 416 is sucked into portable computing device 400 by way of vents in an enclosure encasing portable computing device 400. Coolant flow 416 is driven first across heat pipe 406 and processor 404 resulting in a certain amount of heat being convectively transferred to coolant flow 416. Coolant flow 416 is then sucked into fan assemblies 412 and 414 and blown across cooling fin arrays 408 and 410. Consequently, heat is transferred to coolant flow 416 in two distinct steps: (1) heat is transferred to coolant flow 416 as it enters and is blown across the processor and heat pipe; and (2) as coolant flow 416 blows over staggered cooling fin arrays 408 and 410.

Staggering the fins in staggered cooling fin arrays 408 and 410 makes the heat fin arrays more efficient, and causes an increasing proportion of heat transferred into the air flow to occur during the second heat transfer step, across staggered cooling fin arrays 408 and 410. As a result of the shift in heat flow dissipation location, air flowing into the staggered cooling fin arrays arrives at a lower temperature thereby allowing the staggered cooling fin arrays to operate even more efficiently. It should be noted that staggered cooling fins have seen not been exploited in portable computing device design because on a theoretical level, in an isolated heat dissipation system, staggered cooling fins cause a pressure drop not generally associated with conventional heat fins. So, while staggering the heat fins does increase the overall efficiency, the increased efficiency comes at the cost of an increased pressure drop, thereby neutralizing any gains achieved. However, when the staggered cooling fins are utilized in a system to shift a balance between cooling elements, testing has shown significant benefits in overall heat rejection efficiency. Since cooling fin arrays 408 and 410 are more efficient an increased amount of heat tends to flow through heat pipe 406, thereby reducing the amount of heat transferred to coolant flow 416 as it flows across heat pipe 406 and processor 404. Consequently, coolant flow 416 arrives at the entrance of cooling fin arrays 408 and 410 at a lower relative temperature, thereby allowing cooling fin arrays 408 and 410 to operate more efficiently.

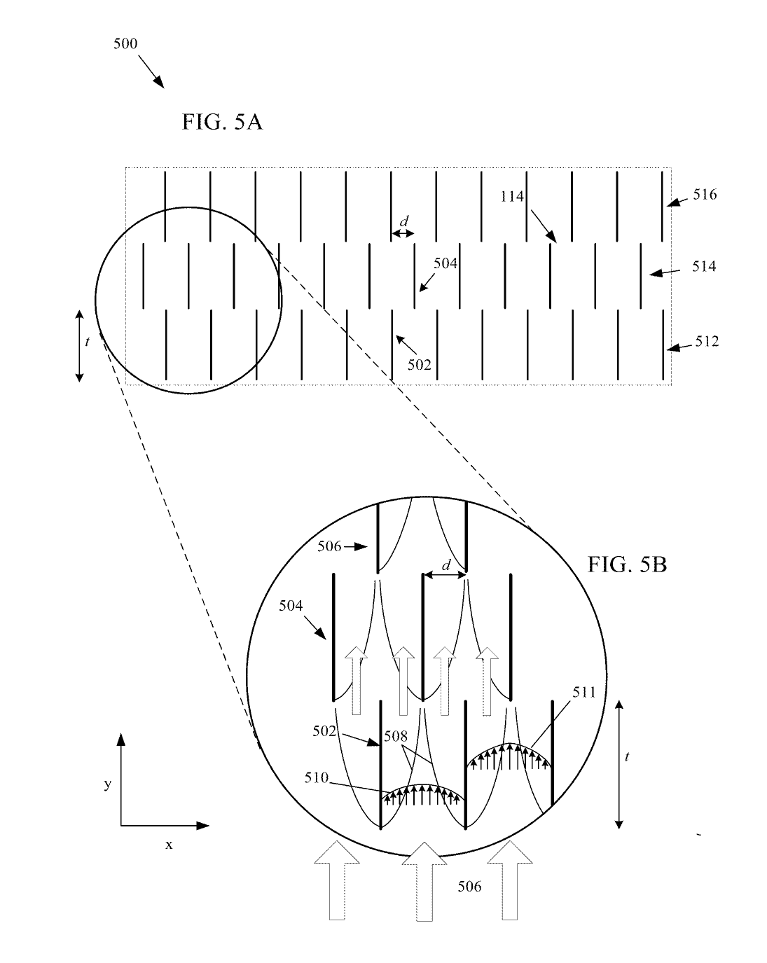

FIGS. 5A and 5B shows an alternative staggered fin embodiment in which three sets of staggered fins are configured in a single heat exchanger. FIG. 5A shows a top down cross-sectional view 500 of representative cooling fins 502 corresponding to first plurality of cooling fins 512, cooling fins 504 representative of second plurality of cooling fins 514, and cooling fins 5076 representative of third plurality of cooling fins 516 each of which are displaced in the “x” direction the staggering distance d and in the “y” direction a distance “t”. In a preferred embodiment distance “d” can be set to a value placing fins 504 halfway between fins 502 and distance “t” can be equal to the length of cooling fins 502, as depicted. It should be noted that in some systems it may be advantageous for staggered fins to overlap with each other, thereby maximizing surface area of the cooling fins for a given extension of the fins in the y-axis. When compared with the heat exchanger depicted in FIGS. 3A and 3B, the arrangement depicted in FIG. 5A allows for a heat exchanger to extend farther into the y-axis. This might be desirable when, for example, fins are more tightly spaced together and as a result viscous effects start degrading flow more quickly. In this situation three staggered rows, or potentially even more might be necessary to achieve a heat exchanger extending all the way across an associated heat pipe. As the length of the cooling fins 502 shorten the heat exchanger starts to look and act more like a pin fin heat exchanger which can be desirable in cases where certain levels of efficiency are required for a given heat rejection system. A pin fin heat exchanger has an array of pins instead of fins which can result in a reduced amount of parasitic boundary layer development that is commonly associated with longer cooling fin based heat exchangers.

FIG. 5B shows how velocity profile 510 of coolant flow 506 develops into velocity profile 511 as it traverses down cooling fins 502. As depicted plumes 508 tend to slow the velocity of the portion of coolant flow 506 which is closer to cooling fins 502, while central portions of the coolant flow 506 are accelerated to keep incompressible coolant flow 506 continuously flowing through the staggered fins. When coolant flow 506 hits cooling fins 504 and 506 it incurs a slight pressure drop as it maneuvers around the fins, but as depicted the staggering prevents the conversion of plumes 508 over the length of the staggered fins.

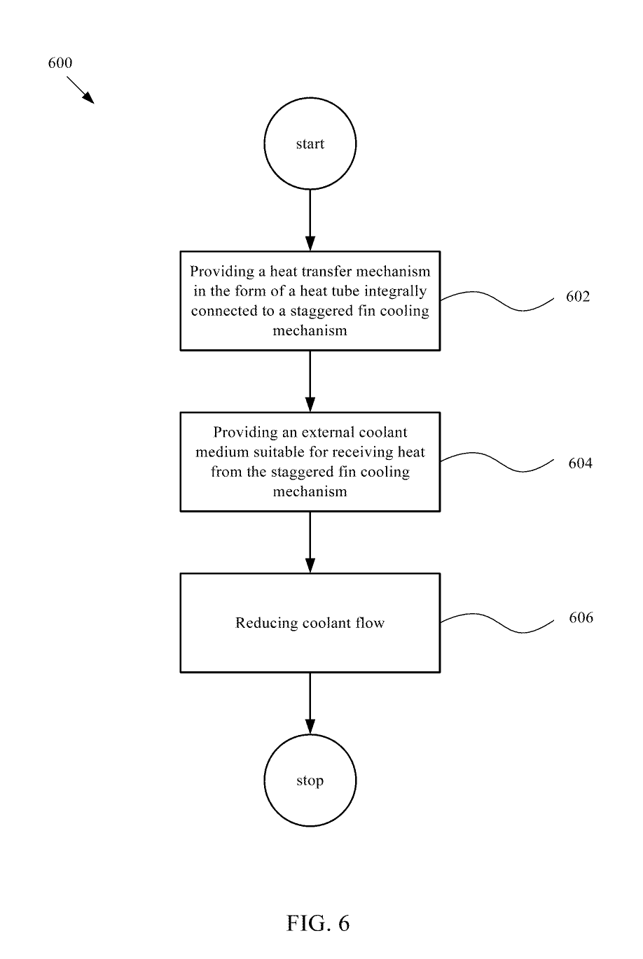

FIG. 6 shows a flowchart describing process 600 for removing heat generated by an integrated circuit. In the described embodiment, the integrated circuit is mounted to a substrate that in turn is mounted to a motherboard. Generally, the motherboard will be a component arranged inside a closed device enclosure. The method can be carried out by performing at least the following operations. Providing a heat transfer mechanism in the form of a heat tube integrally connected to a staggered fin cooling mechanism at 602. At 604, providing an external coolant medium suitable for receiving heat from the staggered fin cooling mechanism. In one embodiment, the external coolant takes the form of air transported by a fan assembly that receives power from an on board power supply. The external coolant can flow over both the integrated circuit and the staggered fin cooling mechanism. As efficiency of the staggered fin cooling mechanism increases a commensurably higher amount of heat is transferred to the external coolant across the staggered fin cooling mechanism than is transferred as the coolant passes across the integrated circuit. At 606, when an amount of heat transferred from the heat tube to the coolant medium is sufficient to maintain the integrated circuit at a predetermined range of operating temperatures, power to the cooling fan is reduced resulting in a reduced coolant flow at the staggered fin assembly.

Accordingly, with the improved efficiency of cooling fin arrangement 200, an amount of coolant required for an amount of heat removal can be reduced. This reduction in the amount of coolant required for heat removal can be accomplished in a number of ways. One such approach can be to reduce the volumetric flow of coolant by reducing fan power (and the concomitant reduction in air flow). In some cases, the efficiency of the staggered fin assembly can be sufficient to obviate the need for a fan assembly at all.

While this invention has been described in terms of several preferred embodiments, there are alterations, permutations, and equivalents, which fall within the scope of this invention. It is therefore intended that the following appended claims be interpreted as including all such alterations, permutations, and equivalents as fall within the true spirit and scope of the present invention.

What is claimed is:

1. A compact computer heat removal system used for removing heat generated by an integrated circuit, the integrated circuit mounted to a substrate, the substrate mounted to a motherboard, comprising:
a heat pipe in thermal contact with the integrated circuit, the heat pipe arranged to carry a heat exchanging medium, the heat exchanging medium used to transfer heat generated by the integrated circuit away from it;
a heat exchanger in thermal contact with the heat pipe, configured to dissipate heat removed by the heat pipe from the plurality of integrated circuits, the heat exchanger comprising:
a first plurality of cooling fins, and
a second plurality of cooling fins, each of which are displaced from a corresponding one of the first plurality of cooling fins by a staggering distance d in a first direction and distance “t” in a second direction, wherein the staggering distance d is such that each of the second plurality of cooling fins is about halfway between corresponding ones of the first plurality of cooling fins, and wherein the distance “t” is less than a distance in which boundary layers formed by friction between a coolant flow and the first plurality of fins combine to substantially occlude the coolant flow, wherein the staggering of the first and the second cooling fins causes a central more thermally receptive portion of the coolant flow to flow over and come in contact with the second plurality of cooling fins thereby increasing a cooling efficiency of the heat exchanger; and
a fan configured to force external coolant flow first across the integrated circuit and subsequently across the heat exchanger.

2. The compact computer heat removal system as recited in claim 1, wherein the forced external coolant is air.

3. The compact computer heat removal system as recited in claim 2, wherein the air is forced through the heat exchanger by a centrifugal fan.

4. The compact computer heat removal system as recited in claim 3, wherein power to the fan assembly is reduced commensurate with efficient transfer of heat between the forced external air and the heat exchanger.

5. The compact computer heat removal system as recited in claim 1, wherein the distance “t” of the first plurality of cooling fins is short enough to prevent parasitic drag from significantly slowing down the forced external coolant flow across the cooling fins.

6. The heat exchanger as recited in claim 5, further comprising:
A third plurality of cooling fins, the second and third plurality of cooling fins spaced apart a staggering distance “e” in a direction perpendicular to an orientation of the second plurality of cooling fins.

7. The heat exchanger as recited in claim 6, wherein the staggering distance “e” is substantially the same as the staggering distance “d”.

8. The compact computer heat removal system as recited in claim 5, wherein the motherboard is encased inside an enclosure having at least one vent for intake and one vent for expulsion of external coolant flow.

9. The compact computer heat removal system as recited in claim 8, wherein the heat pipe is in thermal contact with a plurality of heat exchangers, each heat exchanger having an associated fan to drive coolant flow over its plurality of cooling fins.

10. A method for removing heat generated by an integrated circuit mounted to a substrate that in turn is mounted to a motherboard, comprising:
providing a heat transfer mechanism in the form of a heat tube integrally connected to a staggered fin cooling mechanism; and
providing an external coolant medium suitable for convectively absorbing heat while flowing across at least the staggered fin cooling mechanism and the integrated circuit.

11. The method as recited in claim 10, wherein efficiency of the staggered fin cooling mechanism is high enough to minimize direct convective transfer of heat from the integrated circuit to the external coolant medium, thereby allowing the external coolant medium to arrive at the staggered fin cooling mechanism at a lower temperature than it would otherwise arrive given a less efficient cooling mechanism.

12. The method as recited in claim 11, the staggered fin cooling mechanism comprising:
a first plurality of cooling fins, and
a second plurality of cooling fins, each of which are displaced from a corresponding one of the first plurality of cooling fins by a staggering distance “d” in a first direction and distance “t” in a second direction, wherein the staggering distance “d” is such that each of the second plurality of cooling fins is about halfway between corresponding ones of the first plurality of cooling fins, and wherein the distance “t” is less than a distance in which boundary layers formed by friction between a coolant flow and the first plurality of fins combine to substantially occlude the coolant flow, wherein the staggering of the first and the second cooling fins causes a central more thermally receptive portion of the coolant flow to flow over and come in contact with the second plurality of cooling fins thereby increasing a cooling efficiency of the heat exchanger.

13. The method as recited in claim 12, further comprising:
when an amount of heat transferred to the coolant medium is sufficient to maintain the integrated circuit at a predetermined range of operating temperatures, reducing power to the cooling fan resulting in a reduced coolant flow at the staggered fin assembly.

14. The method as recited in claim 12, wherein the external coolant medium is air and is provided by a centrifugal fan.

15. The method as recited in claim 14, wherein heat is removed from a plurality of integrated circuits all thermally coupled to the heat tube.

16. A portable computer system, comprising:
a motherboard;
a plurality of integrated circuits mounted to the motherboard;
a heat pipe in thermal contact with each of the plurality of integrated circuits, the heat pipe arranged to transfer heat away from the plurality of integrated circuits;
a high efficiency heat exchanger in thermal contact with the heat pipe, configured to dissipate heat removed by the heat pipe from the plurality of integrated circuits, the heat exchanger comprising a plurality of staggered cooling fins; and
a fan configured to force external coolant flow first across at least one of the plurality of integrated circuits and subsequently across the heat exchanger,
wherein the high efficiency of the staggered fin heat exchanger reduces a convective transfer of heat between the forced external coolant flow and the at least one integrated circuit, thereby allowing the forced external coolant flow to arrive at the high efficiency heat exchanger at a lower temperature than it would otherwise given a lower efficiency heat exchanger.

17. The portable computing system as recited in claim 16, further comprising:
a portable computer system enclosure having at least an inlet vent and an exhaust vent,
wherein the forced external coolant flow is air introduced to the system through the inlet vent and exhausted out the exhaust vent.

18. The portable computing system as recited in claim 16, wherein the plurality of staggered cooling fins are arranged in a first and second plurality of cooling fins, the external coolant flow passing between the first plurality of cooling fins before it reaches the second set of cooling fins.

19. The portable computing system as recited in claim 18, wherein the second plurality of cooling fins are staggered from the first plurality of cooling fins a distance “d”, positioning each of the second plurality of cooling fins about halfway between corresponding ones of the first plurality of cooling fins.

20. The portable computing system as recited in claim 19, wherein each of two ends of the heat pipe are in thermal contact with a separate high efficiency heat exchanger.
